(19) United States
(12) Patent Application Publication
(10) Pub. No.: US 2024/0265241 A1
(43) Pub. Date: Aug. 8, 2024

(54) INFERENCE KERNEL OPTIMIZATION IN CONVOLUTIONAL NETWORKS

(71) Applicant: ADVANCED MICRO DEVICES, INC., Santa Clara, CA (US)

(72) Inventors: Insu Yu, Blacksburg, VA (US); Ioan-Cristian Szabo, Milton Keynes (GB)

(21) Appl. No.: 18/374,100

(22) Filed: Sep. 28, 2023

Related U.S. Application Data
(60) Provisional application No. 63/443,664, filed on Feb. 6, 2023.

(51) Int. Cl. G06N 3/0464

(52) U.S. Cl. CPC G06N 3/0464

(57) ABSTRACT

Techniques are described for processing data in a convolutional neural network (CNN) via fused operations within encoder and/or decoder blocks of a feature network to increase computational efficiency and reduce memory usage. Padding units are added to the input data for each convolutional operation within the encoder/decoder blocks. In certain embodiments, the feature network is coupled to a filter network, forming a combined U-Net architecture in which each of one or more decoder blocks of the feature network is coupled to a corresponding block of the filter network, enabling parallel processing of the output feature maps via the corresponding blocks of the filter network.

### BACKGROUND

Artificial neural networks have been widely adopted in numerous applications such as image and voice recognition, natural language processing, and more. Deep learning models, particularly convolutional neural networks (CNNs), have shown remarkable accuracy in these applications, often surpassing human-level performance in certain tasks.

However, these operations typically involve significant computational resources and memory bandwidth. Each layer of a CNN typically involves reading input data from system memory, performing its operations, and then writing the results back to system memory. This process is repeated for every layer in the neural network, resulting in substantial memory read/write operations that can limit the efficiency and speed of the network.

In addition, previous approaches to U-Net architectures have often involved separately processing the data through each layer of the network and then combining the results, which can be inefficient and computationally expensive. There is a need for a more efficient approach to processing data in CNN architectures that can reduce the volume of memory operations and improve computational efficiency.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 depicts an example configuration of a Convolutional Neural Network (CNN).

FIG. 2 illustrates a feature network of a larger U-Net configured in accordance with some embodiments.

FIG. 3 illustrates a fusing of the operations of a CNN encoder block to implement functionality of the internal operations of that encoder block in accordance with various embodiments.

FIG. 4 illustrates a fusing of the operations of a CNN decoder block to implement functionality of the internal operations of that decoder block in accordance with various embodiments.

FIG. 5 illustrates a U-Net architecture demonstrating interconnection between the feature network and a coupled filter network in accordance with some embodiments.

FIG. 6 illustrates an operational flow routine for an encoder block of a CNN configured in accordance with some embodiments.

FIG. 7 is a block diagram of a processing system designed to implement a CNN in accordance with one or more embodiments.

### DETAILED DESCRIPTION

One type of CNN, known as a U-Net, is structured with an encoder-decoder architecture, in which input data is successively encoded to a compressed representation and then decoded back to an output of the original input dimension. U-Nets typically comprise an encoding (downsampling) path and a decoding (upsampling) path, with a bottleneck layer connecting the two. Each path is composed of multiple layers or blocks, each of which performs a specific set of operations. Data processed by the network is passed sequentially through these layers, undergoing transformations that help the network learn complex patterns in the input data.

Embodiments of techniques described herein provide methods, devices, and systems for improving the efficiency and computational speed of U-Nets and other CNNs, specifically by employing a fusion approach in both the encoder and decoder blocks of the network. This fusion approach involves processing all the operations within a single block (e.g., encoder block, decoder block, etc.) without resorting to external memory reads and writes after each operation, thereby reducing the volume of memory operations typically associated with processing each layer in the network.

In certain embodiments, a novel U-Net architecture is utilized, in which the feature network is integrated with a filter network. In this architecture, not only are the output feature maps from the encoder and decoder blocks in the feature network fused prior to being written to external memory, but they are also provided directly to corresponding stages of the filter network. This allows for processing to be performed in parallel and further increases computational efficiency.

Embodiments described herein may provide additional computational efficiency and reduced memory bandwidth in applications such as image and voice recognition, natural language processing, and other applications in which the speed of the neural network directly supports the performance and functionality provided.

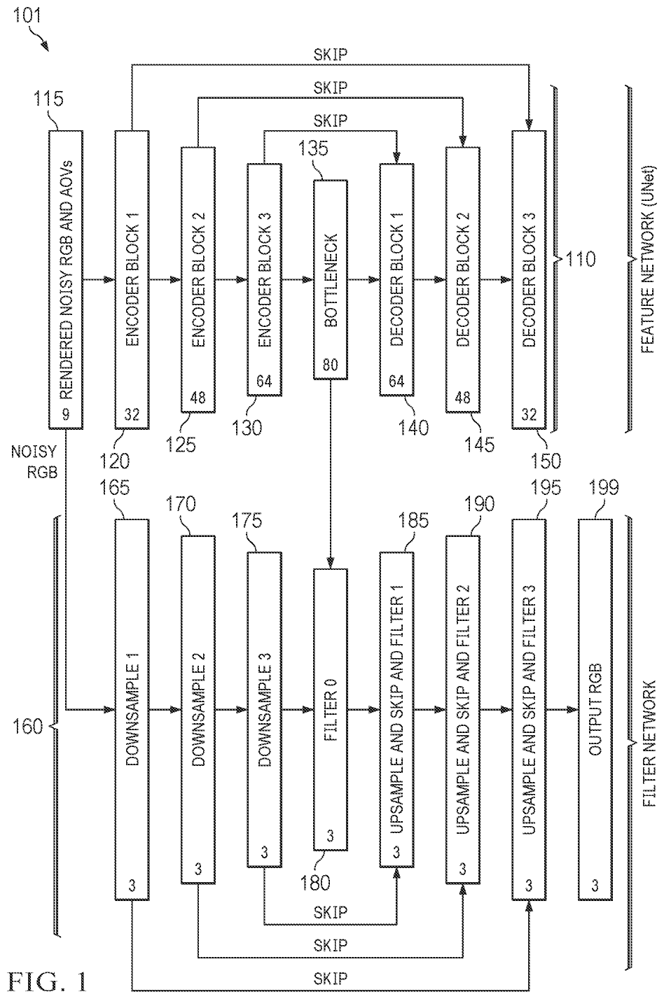

FIG. 1 depicts an example configuration of a Convolutional Neural Network (CNN) 101, which in the depicted example includes a feature network 110 in a U-Net configuration and a filter network 160. In the depicted configuration, the CNN 101 is generally configured (as a non-limiting example) to process noisy image input data 115 to extract and learn features and filters for that input data, thereby reducing the noise in output red-green-blue color (RGB) information data 199. It accomplishes this through a series of encoding, decoding, downsampling, filtering, and upsampling operations, utilizing skip connections to preserve high-frequency details. Each skip connection is a direct path for transmitting information from earlier to later layers in the network, bypassing intermediate layers.

The feature network 110 is responsible for extracting features from input data 115, which represents an input image (e.g., rendered or captured video frame or other image). The input data 115 includes rendered/captured noisy RGB data and, in various scenarios and implementations, additional Arbitrary Output Variables (AOVs). AOVs are auxiliary data points captured during the rendering of a 3D scene to allow enhanced control over post-processing operations, adjustments, and overall scene refinement. Examples of AOVs in various denoising scenarios include information indicating one or more of depth, normals, albedo, diffuse and specular contributions, indirect lighting, object or material IDs, motion vectors, etc.

Operations of the example CNN 101 generally involve input data 115 being provided to and processed by a series of encoder blocks 120, 125, 130 and a bottleneck 135, and subsequently reconstructed by a series of decoder blocks 140, 145, 150. As used herein, a block refers to a functional component or unit of the neural network, which is configured to perform a specific set of operations on input data. Each block is characterized by its function within the architecture of the incorporating CNN and the unique operations it executes to transform the input data, and is implemented using a combination of hardware and software within a processing system. Each block includes underlying circuitry (either exclusive to a particular block or shared between multiple such blocks) that facilitates the operations of a particular block. In various embodiments, such circuitry may comprise one or more processor cores within a central processing unit (CPU), compute units within a graphics processing unit (GPU), or parallel processors, as a non-limiting examples. This circuitry can be programmed or configured to carry out the sequence of data manipulations defined by the block's function. The specific configuration of the circuitry, as well as the programming or instructions that govern its operation, are determined by the function of the block within the CNN and the specific operations it is designed to execute.

For example, circuitry of an encoding block within a U-Net configured CNN (or portion thereof) is configured to perform a series of convolutional and pooling operations to downsample input data, extracting and condensing feature information in the process. The circuitry that implements this block is configured to carry out the specific mathematical operations involved in convolution and pooling on the input data. In contrast, circuitry of a decoding block is configured to perform upsampling on condensed feature information, often through a combination of convolutional operations and concatenation with higher-resolution feature data from the encoding path. This effectively reconstructs the feature information at the original input resolution, with noise reduced or eliminated. The circuitry implementing the decoding block is configured to perform these upsampling and concatenation operations.

Continuing the example of FIG. 1, the first encoder block 120 accepts input data 115 and conducts various operations to extract high-level features from data 115. For example, in certain implementations such operations include one or more of conversion to grayscale and/or gradient magnitude computation, the outputs of which are concatenated and form the input for a first convolution layer. The encoder block 120 typically includes multiple convolution layers, followed by batch normalization and one or more activation operations (e.g., Exponential Linear Unit (ELU), Rectified Linear Unit (ReLU), Sigmoid, Tanh, Softmax, Swish, or other activation operation) and/or downsampling operations, such as via max pooling.

As used herein, a channel or feature map (used interchangeably herein) for a given block indicates the depth of its output tensor and corresponds to an individual outcome generated by a specific operation or set of operations applied by the block. In the example of FIG. 1, each of the encoder blocks 120, 125, 130, bottleneck 135, decoder blocks 140, 145, 150, downsample blocks 165, 170, 175, and filter blocks 180, 185, 190, 195 include an indication of a number of channels or feature maps present at that specific stage in the CNN 101. For example, encoder block 120 indicates a 32-channel output; encoder block 125 indicates a 48-channel output; etc. The progression in the number of channels within successive blocks of the feature network 110 is representative of the increasing complexity of patterns that the CNN 101 is designed to capture from the input data 115 as it advances through the CNN 101. Hence, each block within the CNN 101 operates with a varying number of channels to enable the capture of increasingly intricate features in the input data throughout the network's progression.

The output of the first encoder block 120 is provided to the second encoder block 125, which performs additional operations on the input from encoder block 120 and provides its output to the third encoder block 130. The encoder blocks 120, 125, 130 progressively downsample the input image data 115, enabling network 110 to learn hierarchical features included therein.

The output of the third encoder block 130 feeds into the bottleneck 135, which processes the encoded features received from encoder block 130 without changing their dimensions. The bottleneck 135 is similar to each of encoder blocks 120, 125, 130, but excludes max pooling operations and skip connections. The primary purpose of the bottleneck 135 is to encode the most relevant features of the input data 115.

The first decoder block 140 accepts the output from the bottleneck 135 and begins the process of upsampling and refining the features contained therein, guided by the information from the corresponding encoder block 130 via a skip connection. The second decoder block 145 and the third decoder block 150 operate similarly, each receiving output from both the preceding decoder block and (via additional skip connections) the corresponding encoder block. In this manner, the decoder blocks 140, 145, 150 reconstruct the image data at the original scale.

The filter network 160, executing in parallel to the feature network 110, includes a series of downsample blocks 165, 170, 175. The first downsample block 165 accepts the original input data 115 and provides output to the second downsample block 170. The second downsample block 170, in turn, feeds the third downsample block 175. These blocks 165, 170, 175 progressively reduce the resolution of input data 115, forming a compressed feature map.

This compressed feature map, along with the output from the bottleneck 135, are input to the filter 0 block 180, which provides output to a series of upsample/skip/filter (USF) blocks 185, 190, 195. Each of USF blocks 185, 190, 195 implement a combination of upsampling, skip connection, and filtering operations.

In particular, in the example of FIG. 1 USF block 185 receives input from filter block 180 and decoder block 140. The USF block 185 upsamples the output from filter block 180 (increasing the resolution of the data), and concurrently incorporates data from decoder block 140 via their shared skip connection.

USF block 190 operates in a similar manner, receiving inputs from block 185 and decoder block 145. In particular, USF block 190 upsamples the data from block 185 and integrates the data from decoder block 145 via skip connection. In a manner similar to that described above with respect to USF block 185, the upsampling operation of USF block 190 is performed to enhance the spatial resolution of the output data from block 185, while the skip connection allows for the inclusion of information-rich features from decoder block 145.

USF block 195 receives inputs from block 190 and decoder block 150. It performs similar operations as blocks 185 and 190, upsampling the data from block 190 and integrating data from decoder block 150 via skip connection. The resulting output RGB data 199 has been processed through all stages of the CNN 101, progressively denoised and enhanced in resolution with the inclusion of high-level feature information from the decoder blocks 140, 145, 150.

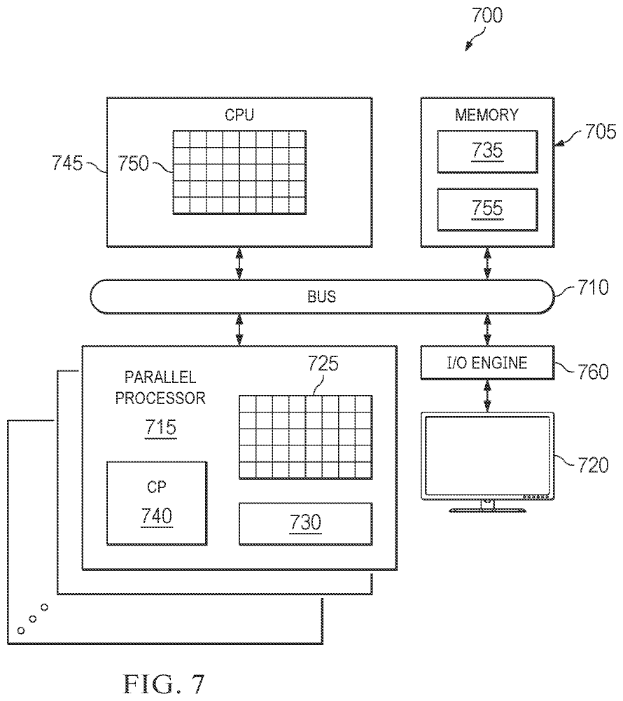

As noted elsewhere herein, a multitude of operations of the CNN 101 depicted in FIG. 1 involve read and write interactions with global system memory (e.g., system memory 705 of FIG. 7, described elsewhere herein). In particular, such interactions may occur at the following stages:
Initial data loading: The loading of input data 115 involves a read operation from the global system memory. This operation allows the CNN 101 to acquire the necessary data for subsequent processing.
Encoder blocks: Each of the encoder blocks 120, 125, and 130 utilize read and write operations to and from the global system memory, such as during the convolutional and max pooling stages to accommodate intermediate results or shared kernel parameters.
Bottleneck: The bottleneck block 135 utilizes read and write operations from the global system memory to handle intermediate results and maintain kernel parameters during its convolutional operations.
Decoder blocks: Similar to the encoder blocks, each of the decoder blocks 140, 145, and 150 typically utilizes read and write operations to and from the global system memory, such as to process intermediate results and share kernel parameters during the convolutional and upscaling stages.
Feature extraction: The filter network 160, including the downsampling blocks 165, 170, and 175, the filter 180, and the upsample/skip/filter blocks 185, 190, and 195, may necessitate read and write operations to and from the global system memory. These operations are utilized for data transformation during the downsampling and upsampling stages and during filter operations for feature extraction.
Final data output: providing output of the CNN 101 utilizes a write operation to the global system memory, storing the denoised image data for subsequent utilization or analysis.

Thus, multiple stages of the CNN 101 utilize read and write interactions with the global system memory, which can impose significant demand on system memory bandwidth when processing the input data provided to the CNN 101.

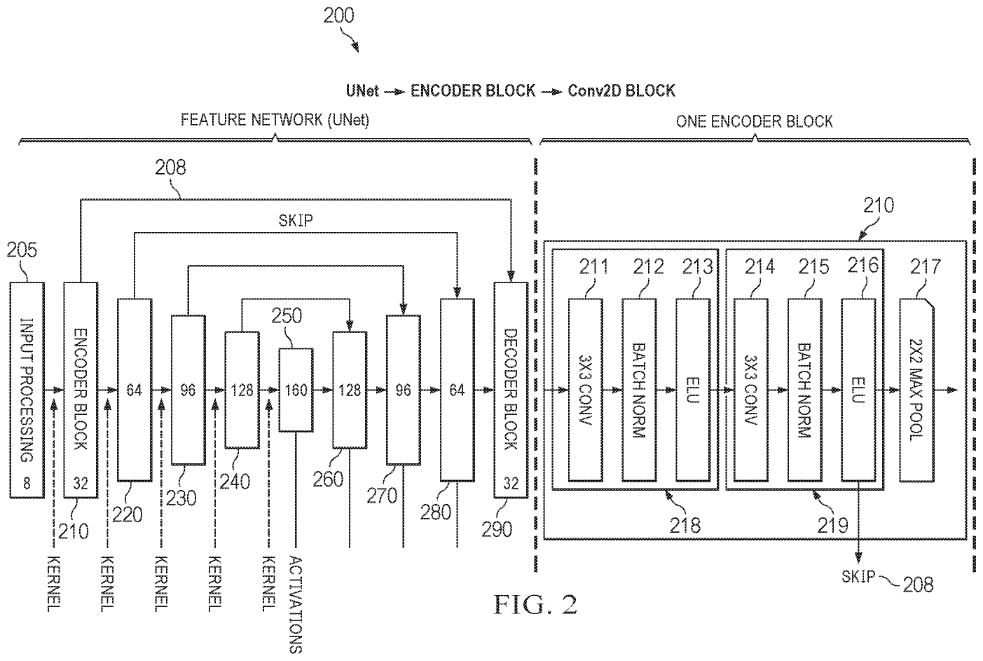

FIG. 2 illustrates a feature network 200 of a larger U-Net (not shown, but which may be considered to operate in a manner similar to that described above with respect to U-Net 100 of FIG. 1). The feature network 200 comprises an input processing block 215, four encoder blocks 210, 220, 230, 240, a bottleneck 250, and four decoder blocks 260, 270, 280, 290.

The first encoder block 210 includes a sequence of operations that are each carried out by a specific element within the encoder block 210. In the depicted embodiment, these operations are performed in series, such that the output from each operation serves as the input for the next.

As used herein, Conv2D refers to an operational block that generally applies a two-dimensional (2D) filter (also called a kernel) to received input data via a single convolution operation and one or more subsequent non-convolutional operations. Such operations result in feature maps that highlight certain features in the input data. For example, in the context of image processing, these features typically indicate edges, textures, or other patterns.

In the embodiment of FIG. 2, the first operation in the encoder block 210 is a 3×3 convolution operation 211 (performed on input data furnished by an initial input processing block 205), followed by a batch normalization operation 212, and then by an ELU activation operation 213. These operations 210, 211, 212 form a single Conv2D sub-block 218, designed to apply a sequence of transformations to the input data provided to the first encoder block 210. Similarly, operations 214, 215, 216 form a second Conv2D block 219. Generally, the Conv2D operations 211, 214 perform convolution; the batch normalization operations 212, 215 improve the stability and performance of the feature network 200 by normalizing the output of the Conv2D operation blocks, and the ELU operations introduce non-linearity into the processing pipeline, which helps the feature network 200 (and its larger U-Net) to model complex patterns in the input data. The operations of second Conv2D block 219 generally apply a second round of transformations to the data already processed by operations of the Conv2D block 218.

The output of ELU operation 216 is the output of the second Conv2D block 219 and is fed as input both to a 2×2 max pool operation 217 (to generate output from the first encoder block 210), and to the corresponding decoder block 290 (via a skip connection 208).

Notably—and in a manner similar to that described with respect to accesses to/from system memory between encoder blocks 210, 220, 230, 240, bottleneck 250, and decoder blocks 260, 270, 280, 290—in previous approaches each operation within the encoder block 210 involves access to/from memory. In particular, as part of providing respective results from operations 211, 212, 213, 214, 215, 216, and 217, each of those seven operations typically involves a read and/or write access to/from one or more system memory locations. Moreover, those seven associated system memory access operations would typically be performed for each of the encoder blocks 210, 220, 230, 240 and decoder blocks 260, 270, 280, 290.

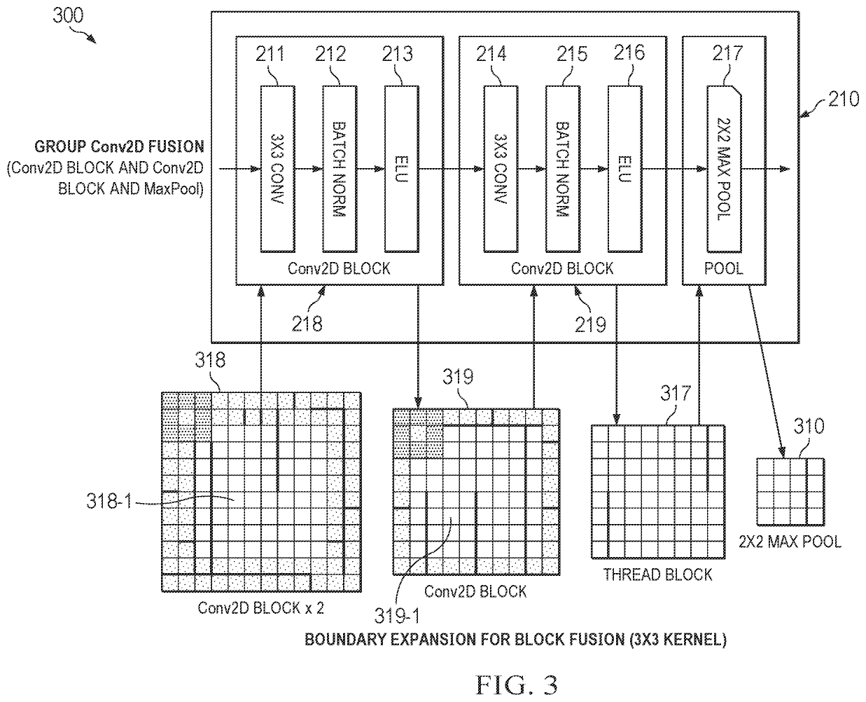

FIG. 3 illustrates a fusing of the operations of the encoder block 210 from FIG. 2, implementing the functionality of both the two Conv2D blocks 218, 219 and the 2×2 max pool operation 217 in accordance with various embodiments. In particular, FIG. 3 illustrates a fusion process 300 performed by the first encoder block 210 of the feature network 200 in accordance with various embodiments. It demonstrates how the individual operations of the encoder block 210 are organized and executed to reduce the overall computational expense, implementing all of those individual operations with a single system memory read access to load initial input data, and a single system memory write operation to store a resulting 4×4 output matrix.

In the depicted embodiment, a 12×12 matrix 318 serves as input to the first Conv2D block 218 of the encoder block 210. The central 8×8 portion of matrix 318, labeled 318-1, represents the units of actual input data (e.g. individual pixels, if the feature network 200 is processing image data), while the surrounding two-square border consists of padding units, added to accommodate the application of the 3×3 kernel during the convolution operation in the first Conv2D block 218. As used herein, a padding unit is a predefined value or set of values added to data to align it to a specific size or structure, such as to ensure that the data conforms to a desired format, to increase the security of encrypted data, or to enhance the performance of certain operations. The actual value(s) and methodology of generating such padding units can vary depending on the specific application and requirements. For example, in various embodiments the padding units may be generated in a variety of ways, such as via zero padding, reflective padding, symmetric padding, edge padding, constant padding, or some combination thereof.

The output of the first Conv2D block 218 is represented by 10×10 output matrix 319, which then serves as input to the second Conv2D block 219. Similar to matrix 318, the central 8×8 portion of matrix 319, labeled 319-1, represents the units of actual output from the first Conv2D block 218 and input data to the second Conv2D block 219, with a one-square border of padding units.

The output of the second Conv2D block 219 is an 8×8 matrix that is the final output of the respective convolution, normalization, and activation operations of the Conv2D blocks 218 and 219. This matrix 317, which in the depicted embodiment is sized to match a size of a thread block for the compute unit assigned to process the encoder block 210, is then provided as input to the 2×2 max pool operation 217.

The output of the max pool operation 217 is represented by the 4×4 fused output matrix 310. The fused output matrix 310 represents the overall output of the encoder block 210 after fusion. Advantageously, in certain embodiments it is the only data that is written back to system memory after the operations of Conv2D blocks 218, 219 and max pool operation 217 have been performed. This implementation reduces the number of read/write operations to the system memory, thereby improving the computational efficiency of the encoder block 210 within the U-Net structure.

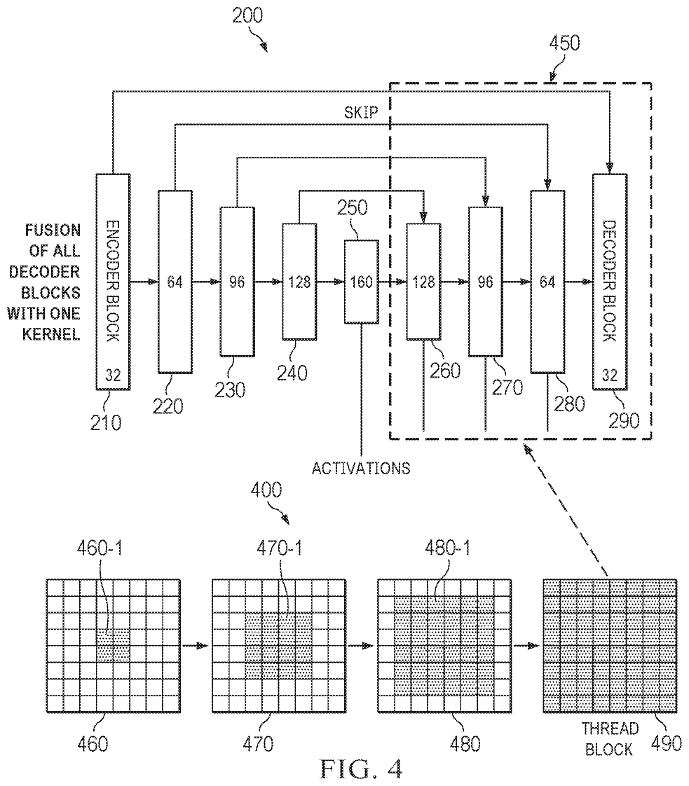

FIG. 4 illustrates a fusion process 400 for decoder blocks 260, 270, 280, 290 in the feature network 200, in accordance with some embodiments. This fusion process mirrors the encoder block fusion process described with respect to FIG. 3, with the decoder blocks involving upsampling operations that increase the size of the relevant input feature maps. The fusion process, similar to the encoder block fusion of FIG. 3, increases computational efficiency and reduces the associated volume of memory read/write operations.

In the depicted embodiment, four matrices 460, 470, 480, and 490 represent the respective outputs of each decoder block 260, 270, 280, 290. Each central shaded submatrix within the matrices 460, 470, 480, 490 signifies the input data being processed by the corresponding decoder block.

Matrix 460 represents the output following the first decoder block operation. It comprises a central 2×2 shaded submatrix 460-1, surrounded by a border of three padding units added after the first decoder block operation. As similarly described above with respect to the padding units of FIG. 3, in various embodiments the padding units may be generated in a variety of ways.

The processed data from matrix 460 is subsequently used as input for the next decoder block 270. The result after this operation is represented by matrix 470, which includes a central 4×4 shaded submatrix 470-1, encompassed by a two-square padding border. The expansion of the shaded submatrix 470-1 indicates the upscaling operation of the decoder block 270.

The output data of the third decoder block 280 is represented by matrix 480, which features a central 6×6 shaded submatrix 480-1, surrounded by a one-square padding border, again indicating an increase in data dimensions.

Finally, an 8×8 thread block matrix 490 is output from decoder block 290, comprising fully processed data without padding. In certain embodiments, only the thread block matrix 490 is written into system memory.

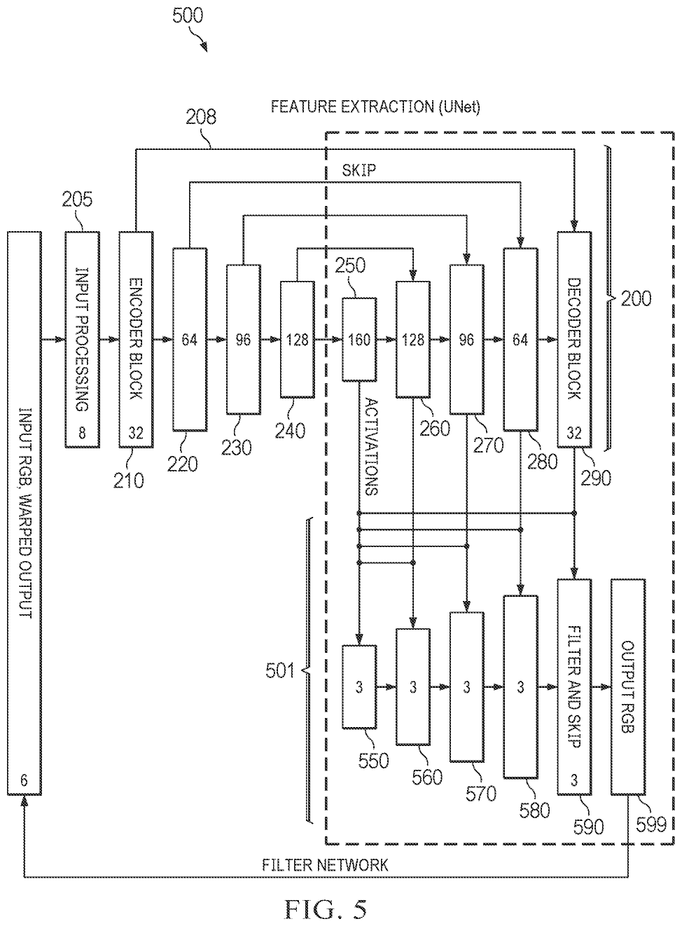

FIG. 5 illustrates a U-Net architecture 500, showing interconnection between the feature network 200 and a filter network 501, in accordance with some embodiments. Unlike some traditional U-Net architectures, where the entire output from the feature network is provided as input to the start of the filter network, the U-Net architecture 500 allows for more intricate interaction between the feature extraction and filtering processes, with individual stages of the feature network coupled to corresponding stages of the filter network 501. In this manner, the U-Net architecture 500 facilitates more detailed and fine-grained processing of input data.

In the depicted embodiment, each layer of the feature network 200—that is, each of bottleneck 250 and decoder blocks 260, 270, 280, and 290—is connected to a corresponding stage in the filter network 501. Bottleneck 250 is coupled to an activation block 550 in the filter network 501, while decoder blocks 260, 270, 280, and 290 each connect to a corresponding filter & skip block 560, 570, 580, 590. These connections are in addition to the forward-feed connections within the respective features/filter networks 200 and 501. For example, the bottleneck 250 still feeds forward to decoder block 260, which in turn feeds forward to decoder block 270, and so on. Similarly, the activation block 550 feeds forward to filter & skip block 560, which then feeds forward to filter & skip block 570, then to filter & skip clock 580, and then to filter & skip block 590, which provides output to output RGB block 599. The output from block 599 is fed back to the input processing block 205 of the feature network 200, closing the loop for the U-Net process.

In certain embodiments, the connections between the corresponding stages of the feature network 200 and filter network 501 employ separable convolution operations, which can offer computational efficiency benefits.

By fusing the operations of corresponding stages within the feature and filter networks, as represented by the connections between them, the U-Net architecture 500 reduces memory read/write operations and enhances computational performance, particularly in scenarios with hardware memory constraints. In certain embodiments, only the output of the final filter & skip block 590 and/or that of output RGB block 599 is written into system memory, further improving memory usage.

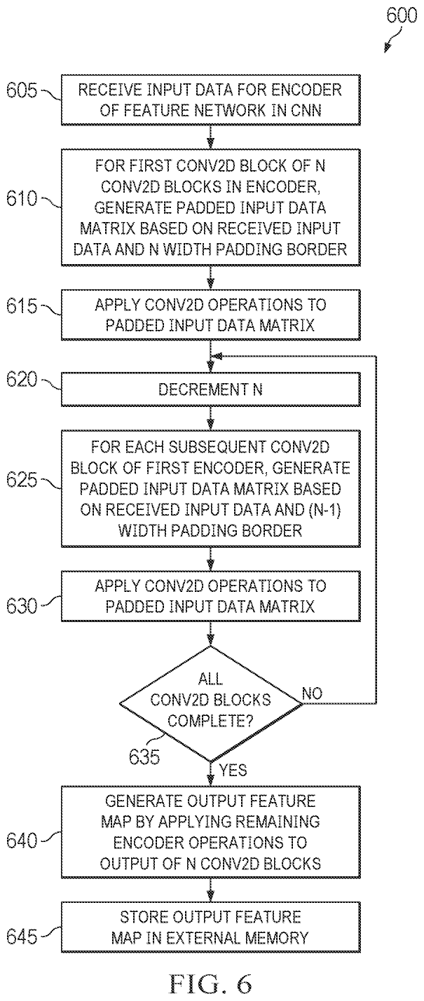

FIG. 6 illustrates an operational flow routine 600 for an encoder block of a feature network configured in accordance with embodiments described herein. The routine commences at 605, where input data is received for an encoder block of a feature network (e.g., feature network 200 of FIGS. 2-5) in a Convolutional Neural Network (CNN).

In 610, for the first two-dimensional convolution (Conv2D) block of a series of N Conv2D blocks in the encoder, a padded input data matrix is generated based on the received input data and an N-unit wide padding border. This padding enables, for example, the successful execution of the convolution operations of the encoder block without needing to access memory external to the encoder block.

At 615, operations of the first Conv2D block are applied to the padded input data matrix, generating transformed data as output.

At 620, N is decremented in preparation for the processing of subsequent Conv2D blocks within the encoder block.

The routine proceeds to 625 for each subsequent Conv2D block within the encoder block. In this step, a new padded input data matrix is generated based on the transformed data from the previous Conv2D block, with a padding border of (N−1) units.

In 630, operations of the current Conv2D block are applied to the newly padded input data matrix.

In 635, if all Conv2D blocks within the encoder block have completed their operations, the routine proceeds to 640. Otherwise, the routine returns to 620 to process the next Conv2D block.

At 640, any remaining operations of the encoder block (e.g., a max pool operation such as max pool operation 217) are applied to the output of the last Conv2D block, generating an output feature map from the encoder block.

Finally, at 645, the output feature map is stored in memory external to the encoder block. Notably, in certain embodiments, storing the output feature map is the only operation accessing external memory other than an initial read of the original input data at 605.

FIG. 7 is a block diagram of a processing system 700 designed to implement a convolutional neural network in accordance with one or more embodiments. The processing system 700 is generally designed to execute sets of instructions or commands to carry out tasks on behalf of an electronic device, such as a desktop computer, laptop computer, server, smartphone, tablet, game console, and the like.

The processing system 700 includes or has access to a memory 705 or other storage component that is implemented using a non-transitory computer readable medium, such as dynamic random access memory (DRAM). The processing system 700 also includes a bus 710 to support communication between entities implemented in the processing system 700, such as the memory 705. In certain embodiments, the processing system 700 includes other buses, bridges, switches, routers, and the like, which are not shown in FIG. 7 in the interest of clarity.

The processing system 700 includes one or more parallel processors 715 that are configured to render images for presentation on a display 720. A parallel processor is a processor that is able to execute a single instruction on multiple data or threads in a parallel manner. Examples of parallel processors include graphics processing units (GPUs), massively parallel processors, single instruction multiple data (SIMD) architecture processors, and single instruction multiple thread (SIMT) architecture processors for performing graphics, machine intelligence, or compute operations. The parallel processor 715 can render objects to produce pixel values that are provided to the display 720. In some implementations, parallel processors are separate devices that are included as part of a computer. In other implementations such as advance processor units, parallel processors are included in a single device along with a host processor such as a central processor unit (CPU). Thus, although embodiments described herein may utilize a graphics processing unit (GPU) for illustration purposes, various embodiments and implementations are applicable to other types of parallel processors.

In certain embodiments, the parallel processor 715 is also used for general-purpose computing. For instance, the parallel processor 715 can be used to implement machine learning algorithms such as one or more implementations of a CNN as described herein. In some cases, operations of multiple parallel processors 715 are coordinated to execute a machine learning algorithm, such as if a single parallel processor 715 does not possess enough processing power to run the machine learning algorithm on its own.

The parallel processor 715 implements multiple processing elements (also referred to as compute units) 725 that are configured to execute instructions concurrently or in parallel. The parallel processor 715 also includes an internal (or on-chip) memory 730 that includes a local data store (LDS), as well as caches, registers, or buffers utilized by the compute units 725. The parallel processor 715 can execute instructions stored in the memory 705 and store information in the memory 705 such as the results of the executed instructions. The parallel processor 715 also includes a command processor 740 that receives task requests and dispatches tasks to one or more of the compute units 725.

The processing system 700 also includes a central processing unit (CPU) 745 that is connected to the bus 710 and communicates with the parallel processor 715 and the memory 705 via the bus 710. The CPU 745 implements multiple processing elements (also referred to as processor cores) 750 that are configured to execute instructions concurrently or in parallel. The CPU 745 can execute instructions such as program code 755 stored in the memory 705 and the CPU 745 can store information in the memory 705 such as the results of the executed instructions.

An input/output (I/O) engine 760 handles input or output operations associated with the display 720, as well as other elements of the processing system 700 such as keyboards, mice, printers, external disks, and the like. The I/O engine 760 is coupled to the bus 710 so that the I/O engine 760 communicates with the memory 705, the parallel processor 715, or the CPU 745.

In operation, the CPU 745 issues commands to the parallel processor 715 to initiate processing of a kernel that represents the program instructions that are executed by the parallel processor 715. Multiple instances of the kernel, referred to herein as threads or work items, are executed concurrently or in parallel using subsets of the compute units 725. In some embodiments, the threads execute according to single-instruction-multiple-data (SIMD) protocols so that each thread executes the same instruction on different data. The threads are collected into workgroups (also termed thread groups) that are executed on different compute units 725. For example, the command processor 740 can receive these commands and schedule tasks for execution on the compute units 725.

In some embodiments, the parallel processor 715 implements a graphics pipeline that includes multiple stages configured for concurrent processing of different primitives in response to a draw call. Stages of the graphics pipeline in the parallel processor 715 can concurrently process different primitives generated by an application, such as a video game. When geometry is submitted to the graphics pipeline, hardware state settings are chosen to define a state of the graphics pipeline. Examples of state include rasterizer state, a blend state, a depth stencil state, a primitive topology type of the submitted geometry, and the shaders (e.g., vertex shader, domain shader, geometry shader, hull shader, pixel shader, and the like) that are used to render the scene.

In some embodiments, the apparatus and techniques described above are implemented in a system including one or more integrated circuit (IC) devices (also referred to as integrated circuit packages or microchips), such as the convolutional neural networks described above with reference to FIGS. 1-7. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method for processing input data via a convolutional neural network (CNN), the method comprising:
receiving input data for a first encoder block of a plurality of encoder blocks that each comprise an encoding series of operations that includes at least one convolution operation;
for each convolution operation in the encoding series of operations of the first encoder block, generating a padded input data matrix by adding a padding border of one or more units to the input data; and
generating an output feature map by applying the encoding series of operations of the first encoder block to the padded input data matrix without accessing memory that is external to the first encoder block.

2. The method of claim 1, wherein generating the output feature map comprises generating an output feature map having smaller dimensions than the padded input data matrix.

3. The method of claim 1, wherein the encoding series of operations of the first encoder block comprises one or more two-dimensional convolution (Conv2D) blocks of operations, each Conv2D block including a convolution operation performed in series with one or more non-convolution transformations on data input to the Conv2D block.

4. The method of claim 3, wherein the first encoder block includes multiple Conv2D blocks followed by a max pool operation.

5. The method of claim 3, wherein the first encoder block includes a quantity N of Conv2D blocks, and wherein adding the padding border of one or more units to the input data includes adding a padding border of N units around the input data.

6. The method of claim 5, wherein N>1, and wherein the method further comprises adding a padding border of (N−1) unit width to output of a first Conv2D block of the first encoder block as input to a subsequent Conv2D block of the first encoder block.

7. The method of claim 1, further comprising storing the output feature map via the memory external to the first encoder block.

8. The method of claim 1, further comprising providing the output feature map from the first encoder block for processing as input data by a second encoder block of the plurality of encoder blocks.

9. The method of claim 1, further comprising:
receiving the output feature map from one encoder block of the plurality of encoder blocks as input data for a first decoder block of a plurality of decoder blocks, each decoder block comprising at least one convolution operation and one or more transformations;
for each convolution operation of the first decoder block, generating a padded input feature map by adding a padding border that is one or more units wide to the input data; and
generating an output feature map by applying the at least one convolution operation and the one or more transformations of the first decoder block to the padded input feature map without accessing memory that is external to the first decoder block.

10. The method of claim 9, further comprising:
providing the output feature map generated by each decoder block of the plurality of decoder blocks as input data to a corresponding filter block of a plurality of filter blocks in a filter network, wherein each filter block applies a set of filtering operations to its respective input data without accessing memory that is external to the filter block.

11. A system for processing input data via a convolutional neural network (CNN), the system comprising:
a memory;
a processor coupled to the memory and configured to execute a plurality of encoder blocks of the CNN, each encoder block comprising an encoding series of operations that includes at least one convolution operation, the processor configured to:
receive input data for a first encoder block;
for each convolution operation in the encoding series of operations of the first encoder block, generate a padded input data matrix by adding a padding border of one or more units to the input data; and
generate an output feature map by applying the encoding series of operations of the first encoder block to the padded input data matrix without accessing the memory.

12. The system of claim 11, wherein the processor is further configured to generate the output feature map having smaller dimensions than the padded input data matrix.

13. The system of claim 11, wherein the encoding series of operations of the first encoder block comprises one or more two-dimensional convolution (Conv2D) blocks of operations, each Conv2D block including a convolution operation performed in series with one or more non-convolution transformations on data input to the Conv2D block.

14. The system of claim 13, wherein the first encoder block includes multiple Conv2D blocks followed by a max pool operation.

15. The system of claim 13, wherein the first encoder block includes a quantity N of Conv2D blocks, and wherein adding the padding border of one or more units to the input data includes adding a padding border of N units around the input data.

16. The system of claim 15, wherein N>1, and wherein the processor is further configured to add a padding border of (N−1) unit width to output of a first Conv2D block of the first encoder block as input to a subsequent Conv2D block of the first encoder block.

17. The system of claim 11, wherein the processor is further configured to store the output feature map via the memory.

18. The system of claim 11, wherein the processor is further configured to provide the output feature map from the first encoder block for processing as input data by a second encoder block of the plurality of encoder blocks.

19. The system of claim 11, wherein the processor is further configured to:
receive the output feature map from one encoder block of the plurality of encoder blocks as input data for a first decoder block of a plurality of decoder blocks, each decoder block comprising at least one convolution operation and one or more transformations;
for each convolution operation of the first decoder block, generate a padded input feature map by adding a padding border that is one or more units wide to the input data; and
generate an output feature map by applying the at least one convolution operation and the one or more transformations of the first decoder block to the padded input feature map without accessing the memory.

20. The system of claim 19, further comprising: a filter network, the filter network comprising a plurality of filter blocks, wherein the processor is further configured to provide the output feature map generated by each decoder block of the plurality of decoder blocks as input data to a corresponding filter block of the plurality of filter blocks, and each filter block applies a set of filtering operations to its respective input data without accessing the memory.
